(19) United States
(12) Patent Application Publication
(10) Pub. No.: US 2026/0265284 A1
(43) Pub. Date: Sep. 10, 2026

(54) SYMMETRICAL HAFNIUM METALLOCENE FOR MAKING POLYMERS WITH BROAD-ORTHOGONAL COMPOSITION DISTRIBUTIONS

(71) Applicant: Dow Global Technologies LLC, Midland, MI (US)

(72) Inventors: Rhett A. Baillie, Missouri City, TX (US); David M. Pearson, Lake Jackson, TX (US); Roger L. Kuhlman, Lake Jackson, TX (US)

(21) Appl. No.: 18/873,554

(22) PCT Filed: Aug. 4, 2023
(86) PCT No.: PCT/US2023/029497

§ 371 Date: Dec. 10, 2024

Related U.S. Application Data
(60) Provisional application No. 63/395,376, filed on Aug. 5, 2022.
(60) Provisional application No. 63/395,369, filed on Aug. 5, 2022.

(51) Int. Cl. C07F 17/00; B01J 31/22; C08F 4/6592; C08F 210/16

(52) U.S. Cl. CPC C07F 17/00; B01J 31/2295; C08F 4/65925; C08F 210/16; B01J 2231/12; B01J 2531/49

(57) ABSTRACT

Embodiments of the present disclosure are directed towards symmetrical hafnium metallocenes having isobutyl cyclopentadienyl ligands, compositions including those symmetrical hafnium metallocenes having isobutyl cyclopentadienyl ligands, and methods utilizing compositions including the symmetrical hafnium metallocenes having isobutyl cyclopentadienyl ligands.

### FIELD OF DISCLOSURE

Embodiments of the present disclosure are directed towards a metallocene, methods of making and using same, and polyolefins made thereby.

### BACKGROUND

Metallocenes can be used in various applications, including as polymerization catalysts. Polymers may be utilized for several products including films, among others. Polymers can be formed by reacting one or more types of monomer in a polymerization reaction. There is continued focus in the industry on developing new and improved materials and/or processes that may be utilized to form polymers.

### SUMMARY

The present disclosure provides various embodiments, including the following.

A symmetrical hafnium metallocene having isobutyl cyclopentadienyl ligands represented by structure (I):

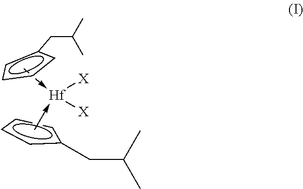

wherein each X is independently a leaving group.

A metallocene catalyst composition comprising the symmetrical hafnium metallocene having isobutyl cyclopentadienyl ligands and an activator.

A method of making the metallocene catalyst composition, the method comprising contacting the symmetrical hafnium metallocene having isobutyl cyclopentadienyl ligands with the activator.

A method of making a polyolefin polymer, the method comprising polymerizing at least one olefin monomer with the metallocene catalyst composition to make the polyolefin polymer.

### BRIEF DESCRIPTION OF THE DRAWINGS

FIG. 1 show data plots utilized to determine molecular weight comonomer distribution index (MWCDI) in accordance with a number of embodiments of the present disclosure.

### DETAILED DESCRIPTION

Symmetrical hafnium metallocenes having isobutyl cyclopentadienyl ligands are discussed herein. Advantageously, these symmetrical hafnium metallocenes having isobutyl cyclopentadienyl ligands can be utilized to make catalyst compositions, for instance. These catalyst compositions can be utilized to make polymers having an improved, i.e., greater, molecular weight comonomer distribution index (MWCDI) as compared to other polymers, made from other metallocenes. These polymers are desirable for a number of applications, including films, among others. As such, providing an improved MWCDI is advantageous. Additionally, these catalyst compositions can be utilized to make polymers having an improved, i.e., greater, comonomer incorporation (C₆ wt. %) as compared to polymer made with made from other metallocenes.

The symmetrical hafnium metallocenes having isobutyl cyclopentadienyl ligands also, as discussed herein, can be used to provide polymers with improved reverse short chain branching distributions. A defining characteristic of polymers such as poly(ethylene-co-1-alkene) resins is the short chain branching distribution (SCBD), or comonomer distribution. For improved product performance in many applications, it is desirable to have a reverse SCBD, or reverse comonomer distribution, where the weight percent (wt. %) of the comonomer in the polymer increases as the molecular weight (MW) of the polymer chains increases. This is also referred to polymers having broad orthogonal composition distributions (BOCD). Such a distribution is usually achieved using a dual reactor configuration and a single or dual catalyst process. In a dual reactor process a single catalyst can be used to make a high MW, lower density component (having higher wt. % comonomer) and a low MW high density (lower wt. % comonomer) component in separate reactors via independent process controls in the two reactors. The result is a bimodal resin that has a reverse SCBD. In the case of a dual catalyst single reactor process, one catalyst makes a high MW low density component, while the other makes a low MW high density component, resulting in a bimodal product having the reverse SCBD.

A more desirable way to achieve polymers having a reverse SCBD is with a single catalyst that can make such a BOCD resin in a single reactor. The symmetrical hafnium metallocenes having isobutyl cyclopentadienyl ligands of the present disclosure, as discussed herein, provides for the ability to produce a polymer with an improved BOCD resin in a single reactor, especially those with measurably greater tendency of comonomer to be enchained in higher-MW fraction and that maintain significant BOCD character across a broad spectrum of process conditions. In addition, there is a need in the industry for low-melt index resins that have broad molecular weight distribution and high BOCD compositions for film and other applications. Without wishing to be bound to theory, it is believed that the iso-butyl groups of the symmetrical hafnium metallocenes of the present disclosure increase the number of primary C(sp³)-H bonds available for C—H activation, thereby increasing the frequency of this reaction and increasing the propensity of the symmetrical hafnium metallocenes catalyst towards multi-sited-ness and creating polymers with BOCD.

The Symmetrical hafnium metallocenes having isobutyl cyclopentadienyl ligands can be represented by structure (I):

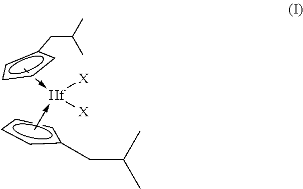

wherein: each X is independently a leaving group. As shown in structure (I), the upper cyclopentadienyl ring is substituted with an isobutyl ligand, and the lower cyclopentadienyl ring is substituted with another isobutyl ligand. As one both cyclopentadienyl rings are substituted with substituted with respective isobutyl ligands, the metallocenes can be referred to as symmetrical metallocenes.

Embodiments of the present disclosure provide that X is a leaving group. One or more embodiments provide that X is selected from alkyls, aryls, hydridos, and halogens. One or more embodiments provide that X is selected from a halogen, (C₁-C₅)alkyl, CH₂SiMe₃, and benzyl. One or more embodiments provide that X is selected from alkyls and halogens. One or more embodiments provide that X is Cl. One or more embodiments provide that X is methyl.

Examples of X include halogen ions, hydrides, (C₁ to C₁₂)alkyls, (C₂ to C₁₂)alkenyls, (C₆ to C₁₂)aryls, (C₇ to C₂₀)alkylaryls, (C₁ to C₁₂)alkoxys, (C₆ to C₁₆)aryloxys, (C₇ to C₈)alkylaryloxys, (C₁ to C₁₂)fluoroalkyls, (C₆ to C₁₂)fluoroaryls, and (C₁ to C₁₂)heteroatom-containing hydrocarbons and substituted derivatives thereof; one or more embodiments include hydrides, halogen ions, (C₁ to C₆)alkyls, (C₂ to C₆) alkenyls, (C₇ to C₁₈)alkylaryls, (C₁ to C₆)alkoxys, (C₆ to C₁₄)aryloxys, (C₇ to C₁₆) alkylaryloxys, (C₁ to C₆)alkylcarboxylates, (C₁ to C₆)fluorinated alkylcarboxylates, (C₆ to C₁₂)arylcarboxylates, (C₇ to C₁₈)alkylarylcarboxylates, (C₁ to C₆)fluoroalkyls, (C₂ to C₆)fluoroalkenyls, and (C₇ to C₁₈)fluoroalkylaryls; one or more embodiments include hydride, chloride, fluoride, methyl, phenyl, phenoxy, benzoxy, tosyl, fluoromethyls and fluorophenyls; one or more embodiments include (C₁ to C₁₂)alkyls, (C₂ to C₁₂)alkenyls, (C₆ to C₁₂)aryls, (C₇ to C₂₀)alkylaryls, substituted (C₁ to C₁₂)alkyls, substituted (C₆ to C₁₂)aryls, substituted (C₇ to C₂₀)alkylaryls, and (C₁ to C₁₂)heteroatom-containing alkyls, (C₁ to C₁₂)heteroatom-containing aryls, and (C₁ to C₁₂)heteroatom-containing alkylaryls; one or more embodiments include chloride, fluoride, (C₁ to C₆)alkyls, (C₂ to C₆)alkenyls, (C₇ to C₁₈)alkylaryls, halogenated (C₁ to C₆)alkyls, halogenated (C₂ to C₆) alkenyls, and halogenated (C₇ to C₁₈)alkylaryls; one or more embodiments include fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls).

Other non-limiting examples of X groups include amines, phosphines, ethers, carboxylates, dienes, hydrocarbon radicals having from 1 to 20 carbon atoms, fluorinated hydrocarbon radicals, e.g., —C₆F₅ (pentafluorophenyl), fluorinated alkylcarboxylates, e.g., CF₃C(O)O—, hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, and dimethylphosphide radicals, among others. In one embodiment, two or more X's form a part of a fused ring or ring system. In one or more embodiments, X can be a leaving group selected from the group consisting of chloride ions, bromide ions, (C₁ to C₁₀)alkyls, (C₂ to C₁₂)alkenyls, carboxylates, acetylacetonates, and alkoxides. In one or more embodiments, X is methyl.

The Symmetrical hafnium metallocenes having isobutyl cyclopentadienyl ligands discussed herein can be made by contacting a hafnium complex with an alkali metal complex to make the symmetrical hafnium metallocenes having isobutyl cyclopentadienyl ligands. The symmetrical hafnium metallocenes discussed herein can be made by processes, e.g., with conventional solvents, reaction conditions, reaction times, and isolation procedures, utilized for making known metallocenes.

The alkali metal complex can be represented by the following structure:

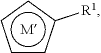

wherein M′ is lithium, sodium, or potassium and R¹ is an isobutyl group.

One or more embodiments provide that the hafnium complex can be hafnium tetrachloride.

One or more embodiments provide that a method of making the symmetrical hafnium metallocenes having isobutyl cyclopentadienyl ligands, e.g., where each X is Cl, comprises contacting the symmetrical hafnium metallocenes having isobutyl cyclopentadienyl ligands with two mole equivalents of an organomagnesium halide of formula RMg(halide) or one mole equivalent of R₂Mg, wherein R is (C₁-C₅)alkyl, CH₂SiMe₃, or benzyl; and the halide is Cl or Br, to make the symmetrical hafnium metallocene of structure (I) wherein each X is a halogen, a (C₁-C₅)alkyl, CH₂SiMe₃, or benzyl. One or more embodiments provide X is a (C₁-C₅)alkyl, CH₂SiMe₃, or benzyl. One or more embodiments provide X is Cl or CH₃. As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, an “alkyl” includes linear, branched, and cyclic paraffin radicals that are deficient by one hydrogen. Thus, for example, CH₃ (“methyl”) and CH₂CH₃ (“ethyl”) are examples of alkyls.

As used herein, an “alkenyl” includes linear, branched, and cyclic olefin radicals that are deficient by one hydrogen; alkynyl radicals include linear, branched, and cyclic acetylene radicals deficient by one hydrogen radical.

As used herein, “aryl” groups include phenyl, naphthyl, pyridyl and other radicals whose molecules have the ring structure characteristic of benzene, naphthylene, phenanthrene, anthracene, etc. It is understood that an “aryl’ group can be a C₆ to C₂₀ aryl group. For example, a C₆H₅ aromatic structure is an “phenyl”, a C₆H₄ aromatic structure is an “phenylene”. An “arylalkyl” group is an alkyl group having an aryl group pendant therefrom. It is understood that an “aralkyl” group can be a (C₇ to C₂₀ aralkyl group). An “alkylaryl” is an aryl group having one or more alkyl groups pendant therefrom.

As used herein, an “alkylene” includes linear, branched, and cyclic hydrocarbon radicals deficient by two hydrogens. Thus, CH₂ (“methylene”) and CH₂CH₂ (“ethylene”) are examples of alkylene groups. Other groups deficient by two hydrogen radicals include “arylene” and “alkenylene”.

As used herein, the term “heteroatom” includes any atom selected from the group consisting of B, Al, Si, Ge, N, P, O, and S. A “heteroatom-containing group” is a hydrocarbon radical that contains a heteroatom and may contain one or more of the same or different heteroatoms, and from 1 to 3 heteroatoms in a particular embodiment. Non-limiting examples of heteroatom-containing groups include radicals (monoradicals and diradicals) of imines, amines, oxides, phosphines, ethers, ketones, oxoazolines heterocyclics, oxazolines, and thioethers.

As used herein, the term “substituted” means that one or more hydrogen atoms in a parent structure has been independently replaced by a substituent atom or group.

The symmetrical hafnium metallocenes having isobutyl cyclopentadienyl ligands discussed herein can be utilized to make catalyst compositions. These compositions include the symmetrical hafnium metallocenes having isobutyl cyclopentadienyl ligands discussed herein and an activator. One or more embodiments provide that the activator is an alkylaluminoxane such as methylaluminoxane. As used herein, “activator” refers to any compound or combination of compounds, supported, or unsupported, which can activate a complex or a catalyst component, such as by creating a cationic species of the catalyst component. For example, this can include the abstraction of at least one leaving group, e.g., the “X” groups described herein, from the metal center of the complex/catalyst component, e.g., the symmetrical hafnium metallocenes having isobutyl cyclopentadienyl ligands of Structure (I). The activator may also be referred to as a “co-catalyst”. As used herein, “leaving group” refers to one or more chemical moieties bound to a metal atom and that can be abstracted by an activator, thus producing a species active towards olefin polymerization. Various catalyst compositions, e.g., olefin polymerization catalyst compositions, are known in the art and different known catalyst composition components may be utilized in various amounts of known catalyst composition components may be utilized for different applications.

The symmetrical hafnium metallocenes having isobutyl cyclopentadienyl ligands discussed herein can be utilized to make spray-dried compositions. As used herein, “spray-dried composition” refers to a composition that includes a number of components that have undergone a spray-drying process. Various spray-drying process are known in the art and are suitable for forming the spray-dried compositions disclosed herein. One or more embodiments provide that the spray-dried composition comprises a trim composition.

In one or more embodiments, the spray-drying process may comprise atomizing a composition including the symmetrical hafnium metallocene having isobutyl cyclopentadienyl ligands discussed herein. A number of other known components may be utilized in the spray-drying process. An atomizer, such as an atomizing nozzle or a centrifugal high speed disc, for example, may be used to create a spray or dispersion of droplets of the composition. The droplets of the composition may then be rapidly dried by contact with an inert drying gas. The inert drying gas may be any gas that is non-reactive under the conditions employed during atomization, such as nitrogen, for example. The inert drying gas may meet the composition at the atomizer, which produces a droplet stream on a continuous basis. Dried particles of the composition may be trapped out of the process in a separator, such as a cyclone, for example, which can separate solids formed from a gaseous mixture of the drying gas, solvent, and other volatile components.

A spray-dried composition may have the form of a free-flowing powder, for instance. After the spray-drying process, the spray-dried composition and a number of known components may be utilized to form a slurry. The spray-dried composition may be utilized with a diluent to form a slurry suitable for use in olefin polymerization, for example. In one or more embodiments, the slurry may be combined with one or more additional catalysts or other known components prior to delivery into a polymerization reactor.

In one or more embodiments, the spray-dried composition may be formed by contacting a spray dried activator particle, such as spray dried MAO, with a solution of the symmetrical hafnium metallocene having isobutyl cyclopentadienyl ligands discussed herein. Such a solution typically may be made in an inert hydrocarbon solvent, for instance, and is sometimes called a trim solution. Such a spray-dried composition comprised of contacting a trim solution of the symmetrical hafnium metallocene having isobutyl cyclopentadienyl ligands with a spray dried activator particle, such as spray-dried MAO, may be made in situ in a feed line heading into a gas phase polymerization reactor by contacting the trim solution with a slurry, typically in mineral oil, of the spray-dried activator particle. Alternatively, the spray-dried composition may be formed by contacting a slurry of the spray dried activator particle (such as a mineral oil slurry of the spray dried activator particle) with the symmetrical hafnium metallocene having isobutyl cyclopentadienyl ligands discussed herein.

Various spray-drying conditions may be utilized for different applications. For instance, the spray-drying process may utilize a drying temperature from 115° C. to 185° C. Other drying temperatures are possible, where the temperature can depend on the metallocene and activator particle. Various sizes of orifices of the atomizing nozzle employed during the spray-drying process may be utilized to obtain different particle sizes. Alternatively, for other types of atomizers such as discs, rotational speed, disc size, and number/size of holes may be adjusted to obtain different particle sizes. One or more embodiments provide that a filler may be utilized in the spray-drying process. Different fillers and amounts thereof may be utilized for various applications.

The symmetrical hafnium metallocenes having isobutyl cyclopentadienyl ligands discussed herein, e.g., catalyst compositions, such as the spray-dried hafnium metallocene composition, may be utilized to make a polymer. For instance, the symmetrical hafnium metallocene having isobutyl cyclopentadienyl ligands may be activated, i.e., with an activator, to make a catalyst. One or more embodiments provide that the spray-dried compositions include an activator. As used herein, “activator” refers to any compound or combination of compounds, supported, or unsupported, which can activate a complex or a catalyst component, such as by creating a cationic species of the catalyst component, e.g., to provide the catalyst. The activator may also be referred to as a “co-catalyst”. The activator can include a Lewis acid or a non-coordinating ionic activator or ionizing activator, or any other compound including Lewis bases, aluminum alkyls, and/or conventional-type co-catalysts. Activators include methylaluminoxane (MAO) and modified methylaluminoxane (MMAO), among others. One or more embodiments provide that the activator is methylaluminoxane. Activating conditions are well known in the art. Known activating conditions may be utilized.

A molar ratio of metal, e.g., aluminum, in the activator to hafnium in the symmetrical hafnium metallocenes having isobutyl cyclopentadienyl ligands may be 1500:1 to 0.5:1, 300:1 to 1:1, or 150:1 to 1:1. One or more embodiments provide that the molar ratio of in the activator to hafnium in the symmetrical hafnium metallocenes having isobutyl cyclopentadienyl ligands is at least 75:1. One or more embodiments provide that the molar ratio of in the activator to hafnium in the symmetrical hafnium metallocenes having isobutyl cyclopentadienyl ligands is at least 100:1. One or more embodiments provide that the molar ratio of in the activator to hafnium in the symmetrical hafnium metallocenes having isobutyl cyclopentadienyl ligands is at least 150:1.

The symmetrical hafnium metallocenes having isobutyl cyclopentadienyl ligands discussed herein, as well as a number of other components, can be supported on the same or separate supports, or one or more of the components may be used in an unsupported form. Utilizing the support may be accomplished by any technique used in the art. One or more embodiments provide that the spray-dry process is utilized. For example, the symmetrical metallocene having isobutyl cyclopentadienyl ligands in an inert solvent can be contacted with a supported or spray dried activator (or slurry thereof) to give a spray-dried metallocene catalyst composition. Alternatively, a supported symmetrical hafnium metallocenes of the present disclosure, as well as a number of other components, can be formed by drying a slurry of constituents under a vacuum or reduced pressure. The support may be functionalized. One or more embodiments provide that the spray-dried compositions include a support.

A “support”, which may also be referred to as a “carrier”, refers to any support material, including a porous support material, such as talc, inorganic oxides, and inorganic chlorides. Other support materials include resinous support materials, e.g., polystyrene, functionalized or crosslinked organic supports, such as polystyrene divinyl benzene polyolefins or polymeric compounds, zeolites, clays, or any other organic or inorganic support material and the like, or mixtures thereof.

Support materials include inorganic oxides that include Group 2, 3, 4, 5, 13 or 14 metal oxides. Some preferred supports include silica, fumed silica, alumina, silica-alumina, and mixtures thereof. Some other supports include magnesia, titania, zirconia, magnesium chloride, montmorillonite, phyllosilicate, zeolites, talc, clays, and the like. Also, combinations of these support materials may be used, for example, silica-chromium, silica-alumina, silica-titania and the like. One or more embodiments provide that the support is silica. One or more embodiments provide that the support is hydrophobic fumed silica. One or more embodiments provide that the support is dehydrated silica. Additional support materials may include porous acrylic polymers, nanocomposites, aerogels, spherulites, and polymeric beads. An example of a support is fumed silica available under the trade name Cabosil™ TS-610, or other TS- or TG-series supports, available from Cabot Corporation. Fumed silica is typically a silica with particles 7 to 30 nanometers in size that has been treated with dimethylsilyldichloride such that a majority of the surface hydroxyl groups are capped.

The symmetrical hafnium metallocenes having isobutyl cyclopentadienyl ligands discussed herein, e.g., the catalyst compositions/spray-dried compositions, and an olefin can be contacted under polymerization conditions to make a polymer, e.g., a polyolefin polymer. The polymerization process may be a suspension polymerization process, a slurry polymerization process, and/or a gas phase polymerization process. The polymerization process may utilize known equipment and reaction conditions, e.g., known polymerization conditions. The polymerization process is not limited to any specific type of polymerization system. The polymer can be utilized for a number of articles such as films, fibers, nonwoven and/or woven fabrics, extruded articles, and/or molded articles.

One or more embodiments provide that the polymers are made utilizing a gas-phase reactor system. One or more embodiments provide that a single gas-phase reactor, e.g., in contrast to a series of reactors, is utilized. In other words, polymerization reaction occurs in only one reactor. For instance, polymers can be made utilizing a fluidized bed reactor. Gas-phase reactors are known and known components may be utilized for the fluidized bed reactor.

As used herein an “olefin,” which may be referred to as an “alkene,” refers to a linear, branched, or cyclic compound including carbon and hydrogen and having at least one double bond. As used herein, when a polyolefin, polymer, and/or copolymer is referred to as comprising, e.g., being made from, an olefin, the olefin present in such polymer or copolymer is the polymerized form of the olefin. For example, when a copolymer is said to have an ethylene content of 75 wt. % to 95 wt. %, it is understood that the polymer unit in the copolymer is derived from ethylene in the polymerization reaction(s) and the derived units are present at 75 wt. % to 95 wt. %, based upon the total weight of the polymer. A higher α-olefin refers to an α-olefin having 3 or more carbon atoms.

Polyolefins made with the compositions discussed herein can be made from olefin monomers such as ethylene (i.e., polyethylene), or propylene (i.e., polypropylene), among other provided herein, where the polyolefin is a homopolymer made only from the olefin monomer (e.g., made with 100 wt. % ethylene or 100 wt. % propylene). Alternatively, polyolefins made with the compositions discussed herein can be made from olefin monomers such as ethylene, i.e., polyethylene, and linear or branched higher alpha-olefin monomers containing 3 to 20 carbon atoms. Examples of higher alpha-olefin monomers include, but are not limited to, propylene, butene, pentene, 1-hexene, and 1-octene. Examples of polyolefins include ethylene-based polymers, having at least 50 wt. % ethylene, including ethylene-1-butene, ethylene-1-hexene, and ethylene-1-octene copolymers, among others. One or more embodiments provide that the polymer can include from 50 to 99.9 wt. % of units derived from ethylene based on a total weight of the polymer. All individual values and subranges from 50 to 99.9 wt. % are included; for example, the polymer can include from a lower limit of 50, 60, 70, 80, or 90 wt. % of units derived from ethylene to an upper limit of 99.9, 99.7, 99.4, 99, 96, 93, 90, or 85 wt. % of units derived from ethylene based on the total weight of the polymer. The polymer can include from 0.1 to 50 wt. % of units derived from comonomer based on the total weight of the polymer. One or more embodiments provide that ethylene is utilized as a monomer and hexene is utilized as a comonomer.

As mentioned, the polymers made with the compositions disclosed herein can be made in a fluidized bed reactor. The fluidized bed reactor can have a reaction temperature from 10 to 130° C. All individual values and subranges from 10° C. to 130° C. are included; for example, the fluidized bed reactor can have a reaction temperature from a lower limit of 10, 20, 30, 40, 50, or 55° C. to an upper limit of 130, 120, 110, 100, 90, 80, 70, or 60° C.

The fluidized bed reactor can have an ethylene partial pressure from 30 pounds per square inch (psi) to 250 psi. All individual values and subranges from 30 to 250 psi are included; for example, the fluidized bed reactor can have an ethylene partial pressure from a lower limit of 30, 45, 60, 75, 85, 90, or 95 psi to an upper limit of 250, 240, 220, 200, 150, or 125 psi.

One or more embodiments provide that ethylene is utilized as a monomer and hexene is utilized as a comonomer. The fluidized bed reactor can have a comonomer to ethylene mole ratio, e.g., C₆/C₂, from 0.0001 to 0.100. All individual values and subranges from 0.0001 to 0.100 are included; for example, the fluidized bed reactor can have a comonomer to ethylene mole ratio from a lower limit of 0.0001, 0.0005, 0.0007, 0.001, 0.0015, 0.002, 0.007, or 0.010 to an upper limit of 0.100, 0.080, or 0.050.

When hydrogen is utilized for a polymerization process, the fluidized bed reactor can have a hydrogen to ethylene mole ratio (H₂/C₂) from 0.00001 to 0.90000, for instance. All individual values and subranges from 0.00001 to 0.90000 are included; for example, the fluidized bed reactor can have a H₂/C₂ from a lower limit of 0.00001, 0.00005, or 0.00008 to an upper limit of 0.90000, 0.500000, 0.10000, 0.01500, 0.00700, or 0.00500. One or more embodiments provide that hydrogen is not utilized.

Melt temperatures were determined using a Differential Scanning Calorimetry according to ASTM D 3418-08.

A number of polymer properties may be determined utilizing Compositional Conventional Gel Permeation Chromatography. For instance, weight average molecular weight (Mw), number average molecular weight (Mn), Z-average molecular weight (Mz), and Mw/Mn (PDI) were determined using a chromatographic system consisted of a PolymerChar GPC-IR (Valencia, Spain) high temperature GPC chromatograph equipped with an internal IR5 infra-red detector (IR5). The autosampler oven compartment was set at 160° C. and the column compartment was set at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968).:

$${M}_{polyethylene} = A \times {( {M}_{polystyrene} )}^{B} \qquad ( EQ 1 )$$

where M is the molecular weight, A has a value of 0.4061 and B is equal to 1.0.

A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

$$Flowrate ( effective ) = Flowrate ( nominal ) * ( RV ( FM Calibrated ) / RV ( FM Sample ) ) \qquad ( EQ 5 )$$

IR5 GPC Octene Composition Calibration. A calibration for the IR5 detector rationing was performed using at least ten ethylene-based polymer standards (Octene as comonomer) made by single-site metallocene catalyst from a single reactor in solution process (polyethylene homopolymer and ethylene/octene copolymers) of a narrow SCB distribution and known comonomer content (as measured by ¹³C NMR Method, Qiu et al., Anal. Chem. 2009, 81, 8585-8589), ranging from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table A.

TABLE A
“Copolymer” Standards

| Wt % | | | | |
|---|---|---|---|---|
| Comonomer | IR5 Area ratio | SCB / 1000 Total C | Mw | Mw/Mn |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

The “IR5 Area Ratio (or “IR5 Methyl Channel Area/IR5 Measurement Channel Area”)” of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “Copolymer” standards. A linear fit of the Wt % Comonomer frequency versus the “IR5 Area Ratio” was constructed in the form of the following Equation 6:

$$Wt \% Comonomer = {A}_{0} + [ {A}_{1} \times ( IR {5}_{Methyl Channel Area} / IR {5}_{Measurement Channel Area} ) ] \qquad ( EQ 6 )$$

where A₀ is the “Wt % Comonomer” intercept at an “IR5 Area Ratio” of zero, and A₁ is the slope of the “Wt % Comonomer” versus “IR5 Area Ratio” and represents the increase in the Wt % Comonomer as a function of “IR5 Area Ratio.” The IR5 area ratio is equal to the IR5 height ratio for narrow PDI and narrow SCBD standard materials.

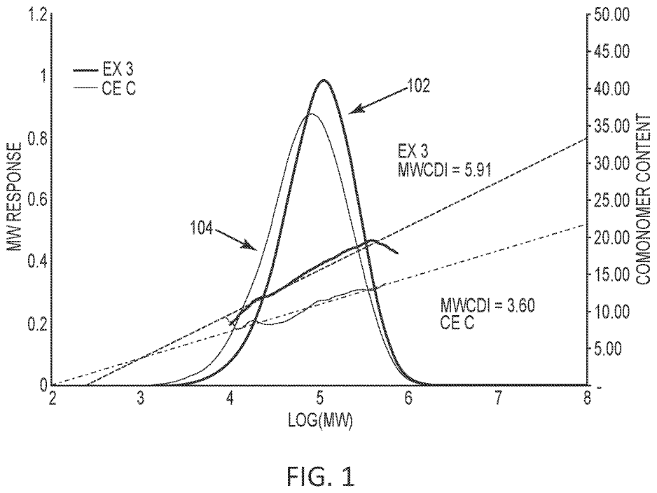

The comonomer distribution, or short chain branching distribution, in an ethylene/α-olefin copolymer can be characterized as either normal (also referred to as having a Zeigler-Natta distribution), reverse, or flat. Several reported methods are utilized to quantify a Broad Orthogonal Composition Distribution (BOCD). Herein, a simple line fit is utilized such that the normal or reverse nature of the comonomer distribution can be quantified by the molecular weight comonomer distribution index (MWCDI), which is the slope of the linear regression of the comonomer distribution taken from a compositional GPC measurement, wherein the x-axis is Log(MW) and the y-axis is weight percent of comonomer. FIG. 1 shows data plots utilized to determine MWCDI for Example 3 (MWCDI=5.91) and Comparative Example C (MWCDI=3.60), as shown in Table 3 of the Examples section of the present application. A reverse comonomer distribution is defined when the MWCDI>0 and a normal comonomer distribution is defined when the MWCDI<0. When the MWCDI=0 the comonomer distribution is said to be flat. Additionally, the MWCDI quantifies the magnitude of the comonomer distribution. Comparing two polymers that have MWCDI>0, the polymer with the greater MWCDI value is defined to have a greater, i.e., increased, BOCD; in other words, the polymer with the greater MWCDI value has a greater reverse comonomer distribution. For instance, as reported in Table 3, the catalyst of Example 2, has an increased BOCD as compared to the catalyst of Comparative Example B. Polymers with a relatively greater MWCDI, i.e., BOCD, can provide improved physical properties, such as improved film performance, as compared to polymers having a relatively lesser MWCDI.

The polymers made with the compositions disclosed herein can have an MWCDI from 0.10 to 10.00. All individual values and subranges from 0.10 to 10.00 are included; for example, the polymer can have a MWCDI from a lower limit of 0.10, 0.50, or 1.00 to an upper limit of 10.00, 9.00, 8.00, 8.50, or 8.35.

The polymers made with the compositions disclosed herein can have a density from 0.8700 to 0.9700 g/cm³. All individual values and subranges from 0.8700 to 0.9700 g/cm³ are included; for example, the polymer can have a density from a lower limit of 0.8700, 0.9000, 0.9100, 0.9150, 0.9200, or 0.9250 g/cm³ to an upper limit of 0.9700, 0.9600, 0.9500, 0.9450, 0.9350, or 0.9300 g/cm³. Density can be determined by according to ASTM D792.

The polymers made with the compositions disclosed herein can have a weight average molecular weight (Mw) from 5,000 to 750,000 g/mol. All individual values and subranges from 5,000 to 750,000 g/mol are included; for example, the polymers can have an Mw from a lower limit of 5,000, 10,000, or 15,000 g/mol to an upper limit of 750,000, 500,000, or 200,000 g/mol. Mw can be determined by gel permeation chromatography (GPC), as is known in the art. GPC is discussed herein.

The polymers made with the compositions disclosed herein can have a number average molecular weight (Mn) from 3,000 to 300,000 g/mol. All individual values and subranges from 3,000 to 300,000 g/mol are included; for example, the polymers can have an Mn from a lower limit of 3,000, 5,000, or 10,000 g/mol to an upper limit of 300,000, 250,000, or 200,000 g/mol. Mn can be determined by GPC.

The polymers made with the compositions disclosed herein can have a Z-average molecular weight (Mz) from 20,000 to 2,000,000 g/mol. All individual values and subranges from 20,000 to 2,000,000 g/mol are included; for example, the polymers can have an Mz from a lower limit of 20,000, 25,000, or 30,000 g/mol to an upper limit of 2,000,000, 1,000,000, 500,000, or 200,000 g/mol. Mz can be determined by GPC.

The polymers made with the compositions disclosed herein can have a weight average molecular weight to number average molecular weight ratio (Mw/Mn) from 1.00 to 6.00. All individual values and subranges from 1.00 to 6.00 are included; for example, the polymers can have an Mw/Mn from a lower limit of 1.00, 1.50, 2.00, or 2.10 to an upper limit of 6.00, 5.50, or 4.50.

A number of aspects of the present disclosure are provided as follows.

Aspect 1 provides a symmetrical hafnium metallocene having isobutyl cyclopentadienyl ligands represented by structure (I):

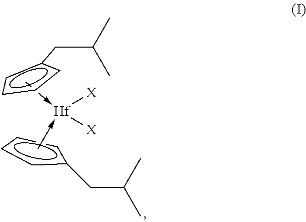

wherein each X is independently a leaving group.

Aspect 2 provides the symmetrical hafnium metallocene having isobutyl cyclopentadienyl ligands of aspect 1, wherein each X is independently a leaving group selected from a halogen, (C₁-C₅)alkyl, CH₂SiMe₃, and benzyl.

Aspect 3 provides the having isobutyl cyclopentadienyl ligands of any one of aspects 1-2, wherein each X is —Cl represented by structure (II):

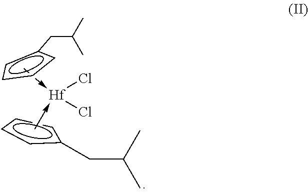

Aspect 4 provides the having isobutyl cyclopentadienyl ligands of any one of aspects 1-2, wherein each X is —CH₃ represented by structure (III):

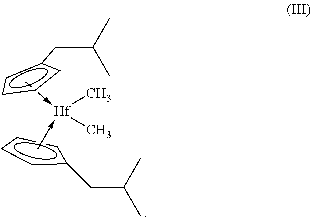

Aspect 5 provides a method of synthesizing the symmetrical hafnium metallocene having isobutyl cyclopentadienyl ligands of any one of aspects 1-4, the method comprising:
contacting a hafnium complex with an alkali metal complex, wherein the alkali metal complex is represented by the following structure:

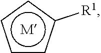

wherein M′ is lithium, sodium, or potassium and R¹ is an isobutyl group; and the hafnium complex is hafnium tetrachloride.

Aspect 6 provides the method of aspect 5, comprising contacting the symmetrical hafnium metallocene having isobutyl cyclopentadienyl ligands with two mole equivalents of an organomagnesium halide of formula RMg(halide) or one mole equivalent of R₂Mg, wherein R is (C₁-C₅)alkyl, CH₂SiMe₃, or benzyl; and the halide is Cl or Br, to make the symmetrical hafnium metallocene having isobutyl cyclopentadienyl ligands of structure (I) wherein each X is (C₁-C₅)alkyl, CH₂SiMe₃, or benzyl.

Aspect 7 provides a metallocene catalyst composition comprising: the symmetrical hafnium metallocene having isobutyl cyclopentadienyl ligands of any one of aspects 1-4, or the symmetrical hafnium metallocene having isobutyl cyclopentadienyl ligands made by the method of aspect 5 or aspect 6; and an activator (e.g., an alkylaluminoxane such as methylaluminoxane).

Aspect 8 provides the metallocene catalyst composition of aspect 7 further comprising a support (e.g., silica such as a hydrophobic fumed silica or a dehydrated silica).

Aspect 9 provides the metallocene catalyst composition of aspect 8, wherein the composition is a spray-dried metallocene catalyst composition.

Aspect 10 provides a method of making the metallocene catalyst composition of any one of aspects 7 to 9, the method comprising either: contacting the symmetrical hafnium metallocene having isobutyl cyclopentadienyl ligands with the activator but not the support, to give the metallocene catalyst composition without a support; or contacting the symmetrical hafnium metallocene having isobutyl cyclopentadienyl ligands with the activator and the support to give the metallocene catalyst composition with the support; or contacting the symmetrical hafnium metallocene having isobutyl cyclopentadienyl ligands with the activator and the support in an inert solvent; or contacting the symmetrical hafnium metallocene having isobutyl cyclopentadienyl ligands with the activator and the support in an inert solvent to give a suspension thereof and spray-drying the suspension to give the spray-dried metallocene catalyst composition; or contacting the symmetrical metallocene having isobutyl cyclopentadienyl ligands in an inert solvent that can be contacted with a supported or spray dried activator (or slurry thereof) to give a spray-dried metallocene catalyst composition.

Aspect 11 provides a method of making a polyolefin polymer, the method comprising: polymerizing at least one olefin monomer with either the metallocene catalyst composition of any one of aspects 7-9, or the metallocene catalyst composition made by the method of aspect 10, to make the polyolefin polymer; wherein preferably the at least one olefin monomer comprises ethylene and, optionally, a comonomer selected from the group consisting of propene and a (C₄-C₂₀)alpha-olefin.

Aspect 12 provides the method of aspect 11, wherein the at least one olefin monomer comprises ethylene and the comonomer; and wherein the polyolefin polymer has a molecular weight comonomer distribution index (MWCDI) from 0.10 to 10.00, as measured by the MWCDI Test Method described herein; wherein preferably the comonomer is selected from the group consisting of 1-butene, 1-hexene, and 1-octene.

Aspect 13 a polyolefin polymer made by the method of any one of aspects 11-12.

### EXAMPLES

5-(2-methylpropylidene)cyclopenta-1,3-diene, which may be represented by the following formula:

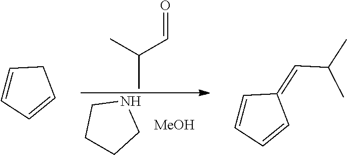

was synthesized as follows. In a glove box, pyrrolidine (1.45 g, 10 mol %) was added to a glass container that contained a solution of isobutyraldehyde (14.6 g, 203 mmol) and cyclopentadiene (13.4 g, 203 mmol) in MeOH—H₂O (200 mL 4/1). The contents of the container were transferred to an ice-cold mixture of brine solution and 10 mol % AcOH in a narrow graduated cylinder. The organic phase was isolated and dried over molecular sieves. The product (5-(2-methylpropylidene)cyclopenta-1,3-diene) was filtered to yield a bright yellow oil, which was subsequently used without further purification (16.0 g, 65%). ¹H NMR (400 MHz, CDCl₃) δ: 6.54 (tdd, J=5.4, 3.8, 2.5 Hz, 2H), 6.51-6.44 (m, 1H), 6.29-6.17 (m, 2H), 3.02 (dp, J=10.0, 6.6 Hz, 1H), 1.15 (d, J=6.6 Hz, 6H). ¹³C NMR (101 MHz, CDCl₃) δ: 149.88, 143.69, 133.08, 130.87, 126.06, 119.36, 30.58, 23.24.

Iso-butylcyclopentadienyl lithium, which may be represented by the following formula:

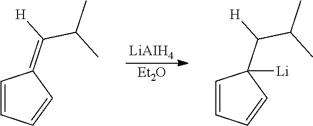

was synthesized as follows.

Et₂O (250 mL) was added to a container. 5-(2 methylpropylidene)cyclopenta-1,3-diene (16.0 g, 133 mmol) was added to the contents of the container while stirring. LiAlH₄ (33 mL, 4 M Et₂O solution) was added dropwise to the contents of the container while stirring. Bubbling was observed. Over the course of the addition a white solid precipitated, a yellow color gradually receded as the LiAlH₄ addition continued. The addition was stopped once the solution became only slightly yellow. The product, iso-butylcyclopentadienyl lithium, observed to be white solid, was collected by filtration, rinsed with Et₂O, and dried under vacuum (13.7 g, 80%).

### Example 1—Synthesis of bis(iso-butylcyclopentadienyl)hafnium dichloride (EX 1)

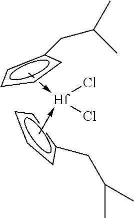

Iso-butylcyclopentadienyl lithium (0.150 g, 17.7 mmol) and hafnium tetrachloride (0.187 g, 0.585 mmol) were added to a container with THE and stirred for approximately 12 hours at approximately 20° C. Then the contents of the container were concentrated to yield an off-white residue. The residue was extracted with dichloromethane and then filtered. The resulting solution was placed under vacuum to yield Example 1 (0.276 g, 96%). ¹H NMR (400 MHz, C₆D₆) δ: 5.83 (t, J=2.7 Hz, 4H), 5.72-5.61 (m, 4H), 2.57 (d, J=7.0 Hz, 4H), 1.62 (dq, J=13.5, 6.8 Hz, 2H), 0.80 (d, J=6.6 Hz, 12H). ¹³C NMR (101 MHz, C₆D₆) δ: 130.67, 116.15, 110.24, 39.50, 30.32, 22.09.

Example 2, a spray-dried composition, was made as follows. In a nitrogen-purged glovebox, hydrophobic fumed silica (CABOSIL TS-610; 1.33 grams) and toluene (37.5 grams) were added to a container and mixed, followed by addition of a 10% solution (11 grams) by weight of methylaluminoxane (MAO) in toluene. Then the contents of the container were stirred for approximately 15 minutes. Then, Example 1 (0.049 grams) was added to the container and the contents of the container were stirred for approximately 30 minutes. Then, the contents of the container were spray-dried utilizing a Buchi Mini Spray Drier B-290 (140° C. set temperature; 100° C. outlet temperature; aspirator 95, 150 rpm pump speed) to provide Example 2 (EX 2).

Comparative Example A (EX A), a hafnium metallocene having two having two n-propyl cyclopentadienyl ligands (bis-(n-propylcyclopentadienyl) hafnium dichloride) was commercially obtained from TCl.

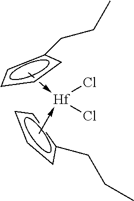

Comparative Example B (CE B), a spray-dried composition, was made as follows. In a nitrogen-purged glovebox, hydrophobic fumed silica (CABOSIL TS-610; 2.65 grams) and toluene (75 grams) were added to a container and mixed, followed by addition of a 10% solution (22 grams) by weight of methylaluminoxane (MAO) in toluene. Then the contents of the container were stirred for approximately 15 minutes. Then, Comparative Example A (0.105 grams) was added to the container and the contents of the container were stirred for approximately 30 minutes. Then, the contents of the container were spray-dried utilizing a Büchi Mini Spray Drier B-290 (140° C. set temperature; 100° C. outlet temperature; aspirator 95, 150 rpm pump speed) to provide Comparative Example B (CE B).

Comparative Example C (CE C), a hafnium metallocene having two having two n-butyl cyclopentadienyl ligands (bis(n-butylcyclopentadienyl)hafnium dichloride) was produced as follows.

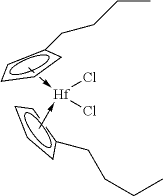

In glove box, a 4 ounce container (first jar) was charged with hafnium tetrachloride (2.068 g) and dimethyl ether (DME, 30 g) to give a white mixture. A solution of n-butylcyclopentadienyl lithium (1.68 g) in DME (30 g) was added slowly to the stirring contents of the first jar, to give an opaque orange mixture. The mixture was allowed to stir at room temperature (20° C.) overnight (18 h), and then the solvent was removed in vacuo. The resulting residue was taken up in toluene and placed in the freezer (−30° C.). Pale orange crystals (0.500 g) of CE C were obtained. Characterization: ¹H NMR (400 MHz, Benzene-d₆) δ 5.83 (t, J=2.7 Hz, 4H), 5.67 (t, J=2.7 Hz, 4H), 2.77-2.62 (m, 4H), 1.50-1.36 (m, 4H), 1.22 (h, J=7.3 Hz, 4H), 0.84 (t, J=7.3 Hz, 6H).

Comparative Example D (CE D), a spray-dried composition, was made as follows. In a nitrogen-purged glovebox, hydrophobic fumed silica (CABOSIL TS-610; 2.65 grams) and toluene (70 grams) were added to a container and mixed, followed by addition of a 10% solution (22 grams) by weight of methylaluminoxane (MAO) in toluene. Then the contents of the container were stirred for approximately 15 minutes. Then, CE C (0.115 grams) was added to the container and the contents of the container were stirred for approximately 30 minutes. Then, the contents of the container were spray-dried utilizing a Büchi Mini Spray Drier B-290 (140° C. set temperature; 100° C. outlet temperature; aspirator 95, 150 rpm pump speed) to provide Comparative Example D (CE D).

Polymerizations were performed as follows. For respective polymerizations, a lab-scale gas phase polymerization reactor (2-liter, stainless steel autoclave equipped with a variable speed mechanical agitator) was dried for one-hour at 100° C. and then charged with dried NaCl (200 g) and heated to 100° C. under a stream of nitrogen for thirty minutes. Then the reactor was purged with nitrogen, 3 g of silica supported methylaluminoxane was added as a scavenger to the reactor, the reactor temperature was adjusted to approximately a desired temperature, the reactor was sealed, and the contents of the reactor were stirred. The reactor was preloaded with hydrogen, ethylene, and 1-hexene to a desired pressure. Upon reaching a steady state, the catalyst was charged into the reactor at a temperature of 80° C. to start polymerization. The reactor temperature was maintained at a desired temperature for the 60-minute polymerization, where hydrogen, C₆/C₂ ratio and ethylene pressure were maintained constant. At the end of the 60-minute polymerization, the reactor was cooled down, vented, and opened. The resulting mixture was washed with water and methanol, and dried. Polymerization conditions for Examples 3-9 and Comparative Examples C—O are reported in Table 1.

A number of properties were determined for polymers respectively made with Examples 3-9 and Comparative Examples C—O. The results are reported in Tables 2 and 3. Catalyst productivity (grams polymer/gram catalyst-hour) was determined as a ratio of polymer produced to an amount of catalyst added to the reactor. Melt index (12) was determined according to ASTM D1238 (190° C., 2.16 kg), melt index (15) was determined according to ASTM D1238 (190° C., 5 kg), melt index (121) was determined according to ASTM D1238 (190° C., 21.6 kg); molecular weight comonomer distribution index (MWCDI) was determined as discussed herein. Melt temperatures were determined using a Differential Scanning Calorimetry according to ASTM D 3418-08, with a scan rate of 10° C./min on a sample of 10 mg was used, and the second heating cycle was used to determine Tₘ. M_{w}, Mₙ, M_{z}, M_{w}/Mₙ (PDI), and M_{z}/M_{w} were determined as discussed above in the detailed description. The comonomer content, e.g., 1-hexene, incorporated in the polymers was determined by rapid FT-IR spectroscopy on the dissolved polymer in a GPC measurement as discussed above in the detailed description.

TABLE 1
Reaction Conditions for Examples (EX) 3-9 and Comparative Examples CE C-O

| | | | | | C₂ | | | |
|---|---|---|---|---|---|---|---|---|
| | | Reaction | | | Partial | Catalyst | | Catalyst |
| | | Temp | | | Pressure | loading | Yield | productivity |
| EX/CE | Catalyst | (° C.) | C₆/C₂ | H₂/C₂ | (psi) | (mg) | (g) | (gPE/gcat/h) |
| EX 3 | EX 2 | 80 | 0.016 | 0.0005 | 220 | 5 | 41.8 | 6836 |
| CE C | CE B | 80 | 0.016 | 0.0005 | 220 | 10 | 109.9 | 10579 |
| CE J | CE D | 80 | 0.016 | 0.0005 | 220 | 5.2 | 27.58 | 5254 |
| EX 4 | EX 2 | 80 | 0.016 | 0.001 | 220 | 6.3 | 72.20 | 11552 |
| CE D | CE B | 80 | 0.016 | 0.001 | 220 | 6.2 | 28.59 | 4612 |
| CE K | CE D | 80 | 0.016 | 0.001 | 220 | 4.7 | 34.38 | 7315 |
| EX 5 | EX 2 | 80 | 0.004 | 0.0003 | 220 | 6.8 | 74.40 | 10941 |
| CE E | CE B | 80 | 0.004 | 0.0003 | 220 | 6.1 | 40.60 | 6655 |
| CE L | CE D | 80 | 0.004 | 0.0003 | 220 | 5.0 | 72.39 | 14335 |
| EX 6 | EX 2 | 80 | 0.001 | 0.0003 | 220 | 6.4 | 98.19 | 15343 |
| CE F | CE B | 80 | 0.001 | 0.0003 | 220 | 6.9 | 43.60 | 6318 |
| CE M | CE D | 80 | 0.001 | 0.0003 | 220 | 4.9 | 85.58 | 17646 |
| EX 7 | EX 2 | 90 | 0.016 | 0.0011 | 230 | 10 | 17.8 | 14087 |
| CE G | CE A | 90 | 0.016 | 0.0011 | 230 | 30 | 177.6 | 5831 |
| EX 8 | EX 2 | 100 | 0.004 | 0.0017 | 230 | 10 | 237.4 | 24254 |
| CE H | CE A | 100 | 0.004 | 0.0017 | 230 | 30 | 105.8 | 3566 |
| CE N | CE D | 100 | 0.004 | 0.002 | 230 | 5.2 | 96.39 | 18717 |
| EX 9 | EX 2 | 90 | 0.016 | 0.0005 | 220 | 5 | 47.6 | 7888 |
| CE I | CE B | 90 | 0.016 | 0.0005 | 220 | 10 | 100.9 | 9165 |
| CE O | CE D | 90 | 0.016 | 0.0005 | 220 | 4.8 | 35.2 | 7328 |

TABLE 2
Polymer Data and BOCD Quantification for Examples (EX) 3-9 and C-O

| | | | | | | | C₆ | Melt Temp |
|---|---|---|---|---|---|---|---|---|
| EX/CE | Catalyst | Mn | Mw | Mz | Mw/Mn | Mz/Mw | (wt. %) | (° C.) |
| EX 3 | EX 2 | 57169 | 156089 | 832761 | 2.73 | 5.34 | 16.3 | 118.1 |
| CE C | CE B | 37995 | 121132 | 280366 | 3.19 | 2.31 | 10.8 | 117.9 |
| CE J | CE D | 38496 | 116586 | 387639 | 3.03 | 3.32 | 7.6 | 118.4 |
| EX 4 | EX 2 | 39315 | 108280 | 724250 | 2.75 | 6.69 | 19.75 | n.c. |
| CE D | CE B | 30938 | 106144 | 1048618 | 3.43 | 9.88 | 14.12 | 113.4 |
| CE K | CE D | 27084 | 77113 | 178339 | 2.85 | 2.31 | 10.7 | 118.2 |
| EX 5 | EX 2 | 46662 | 123787 | 899143 | 2.65 | 7.26 | 2.49 | 126.5 |
| CE E | CE B | 42823 | 119857 | 475814 | 2.80 | 3.97 | 1.17 | 128.0 |
| CE L | CE D | 33849 | 100526 | 226639 | 2.997 | 2.25 | 1.5 | 128.7 |
| EX 6 | EX 2 | 52680 | 149632 | 620216 | 2.84 | 4.14 | 1.76 | 130.4 |
| CE F | CE B | 47184 | 142208 | 722354 | 3.01 | 5.08 | 1.78 | 130.9 |
| CE M | CE D | 46617 | 122982 | 250031 | 2.64 | 2.03 | 0.7 | 131.1 |
| EX 7 | EX 2 | 35950 | 93366 | 187541 | 2.60 | 2.01 | 14.1 | 119.6 |
| CE G | CE A | 33407 | 92905 | 213981 | 2.78 | 2.30 | 9.6 | 119.1 |
| EX 8 | EX 2 | 8172 | 23730 | 48107 | 2.90 | 2.03 | 3.83 | 128.9 |
| CE H | CE A | 15539 | 44727 | 102608 | 2.88 | 2.29 | 3.07 | 129.8 |
| CE N | CE D | 10317 | 31757 | 78474 | 3.08 | 2.47 | 2.1 | 128.2 |
| EX 9 | EX 2 | 51796 | 127647 | 338808 | 2.46 | 2.65 | 14.6 | 97.5 |
| CE I | CE B | 60675 | 163442 | 323504 | 2.69 | 1.98 | 12.9 | 99.4 |
| CE O | CE D | 61466 | 156011 | 369788 | 2.61 | 2.11 | 10.9 | 114.6 |

n.c.—not collected.

TABLE 3
Polymer Data and BOCD Quantification for Examples
(EX) 3-9 and Comparative Examples CE C-O

| | | Melt | Melt | Melt | MFR | MFR | |
|---|---|---|---|---|---|---|---|
| | | Index | Index | Index | (I₂₁/ | (I₂₁/ | |
| EX/CE | Catalyst | (I₂) | (I₅) | (I₂₁) | I₂) | I₅) | MWCDI |
| EX 3 | EX 2 | 0.4 | 0.9 | 6.3 | 17.12 | 6.92 | 5.91 |
| CE C | CE B | 0.9 | 2.2 | 17.5 | 20.27 | 7.81 | 3.60 |
| CE J | CE D | 1.22 | 2.61 | 19.94 | 16.32 | 7.63 | 4.46 |
| EX 4 | EX 2 | 1.529 | 3.829 | 25.541 | 16.70 | 6.67 | 6.63 |
| CE D | CE B | 0.63 | 2.017 | 4.965 | 17.08 | 6.94 | 5.22 |
| CE K | CE D | 4.47 | 10.85 | 71.42 | 15.99 | 6.58 | 4.52 |
| EX 5 | EX 2 | n.c. | n.c. | n.c. | n.c. | n.c. | 0.82 |
| CE E | CE B | 0.04 | 0.984 | 2.499 | 17.11 | 6.74 | 0.32 |
| CE L | CE D | 1.88 | 4.66 | 32.54 | 17.34 | 6.98 | 0.71 |
| EX 6 | EX 2 | 0.583 | 1.419 | 8.91 | 15.28 | 6.28 | 0.61 |
| CE F | CE B | 1.36 | 0.63 | 1.611 | 17.18 | 6.72 | 0.41 |
| CE M | CE D | 0.97 | 2.31 | 15.03 | 15.56 | 6.50 | −0.03 |
| EX 7 | EX 2 | 1.6 | 3.9 | 29.3 | 18.82 | 7.59 | 4.03 |
| CE G | CE A | 2.7 | 7.2 | 55.5 | 20.62 | 7.66 | 2.00 |
| EX 8 | EX 2 | 367.5 | 225.0 | 529.7 | 1.44 | 2.35 | 1.73 |
| CE H | CE A | 33.8 | 91.4 | 684.3 | 20.22 | 7.49 | 0.56 |
| CE N | CE D | 107.2 | 290.3 | 360.8 | 3.37 | 1.24 | 0.95 |
| EX 9 | EX 2 | 0.7 | 1.6 | 10.3 | 15.60 | 6.33 | 2.86 |
| CE I | CE B | 0.3 | 0.7 | 4.8 | 15.81 | 6.50 | 1.67 |
| CE O | CE D | 0.385 | 0.941 | 6.044 | 15.70 | 6.42 | 2.32 |

n.c.—not collected.

The data of Tables 2-3 illustrate that polymers made with EX 2 had a greater quantifiable reverse SCBD, or BOCD (MWCDI), which is a desirable feature. In addition, the polymers made with EX 2 also had higher comonomer incorporation (wt. % C6), which is also a desirable feature. In addition, EX 2 had the following advantages over the CE B catalyst in that the productivity of EX 2 was generally higher than that of CE B, exceptions appear to be only at higher C₆/C₂ (e.g., 0.016) and low H₂/C₂ (e.g., 0.0005), where increasing H₂/C₂ appears to improve the productivity of EX 2 while hurting the productivity of CE B. This would suggest that the EX 2 is a more robust catalyst, tolerant of a wider range of process conditions. In addition, EX 2 had improved, i.e., greater, molecular weight comonomer distribution index as compared to polymer made with CE A or B. In other words, EX 2 was better at incorporating the comonomer (e.g., higher wt. % 1-hexene at same conditions).

FIG. 1 shows data plots utilized to determine MWCDI for Example 3 (MWCDI=5.91) and Comparative Example C (MWCDI=3.6), as shown in Table 3. Data plot 102 corresponds to the determination of MWCDI for Example 3. Data plot 104 corresponds to the determination of MWCDI for Comparative Example C. The polymerization condition for EX 5, CE E and CE L is representative of a higher density polymer and shows that EX 5 maintains good BOCD and a higher MWCDI than the CE E or CE L. EX 7 and CE G were made at an elevated temperature (90° C.), which negatively impacts BOCD. EX 7, however, still maintained a good MWCDI value and is significantly higher than CE G. EX 8, CE H and CE N were polymerized at both a high temperature (100° C.) and a low C₆/C₂ (higher density), which both negatively impact the BOCD (MWCDI) of the CE H and CE N. EX 8 still maintained a considerably higher MWCDI under these more forcing conditions. Finally, EX 9, CE I and CE O were made at a polymerization temperature of 90° C. and a high C₆/C₂ (low density), but at higher H₂/C₂ so that the polymers have melt indices less than 1. EX 9 continued to have a greater MWCDI than the CE I made by the comparative CE B.

1. A symmetrical hafnium metallocene having isobutyl cyclopentadienyl ligands represented by structure (I): 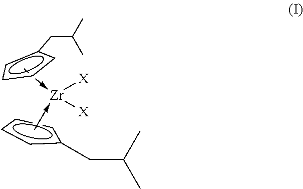
wherein each X is independently a leaving group.

2. The symmetrical hafnium metallocene having isobutyl cyclopentadienyl ligands of claim 1, wherein each X is independently a leaving group selected from a halogen, (C₁-C₅)alkyl, CH₂SiMe₃, and benzyl.

3. The symmetrical hafnium metallocene having isobutyl cyclopentadienyl ligands of claim 1, wherein each X is —Cl represented by structure (II):

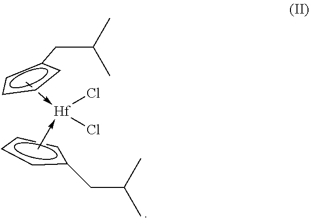

4. The symmetrical hafnium metallocene having isobutyl cyclopentadienyl ligands of claim 1, wherein each X is —CH₃ represented by structure (III):

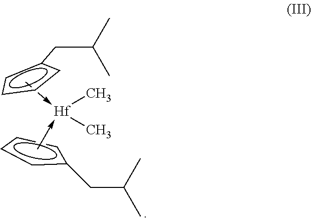

5. A method of synthesizing the symmetrical hafnium metallocene having isobutyl cyclopentadienyl ligands of claim 1, the method comprising:
contacting a hafnium complex with an alkali metal complex, wherein the alkali metal complex is represented by the following structure: 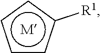
wherein M′ is lithium, sodium, or potassium and R¹ is an isobutyl group; and
the hafnium complex is hafnium tetrachloride.

6. The method of claim 5 comprising contacting the symmetrical hafnium metallocene having isobutyl cyclopentadienyl ligands with two mole equivalents of an organomagnesium halide of formula RMg(halide) or one mole equivalent of R₂Mg, wherein R is (C₁-C₅)alkyl, CH₂SiMe₃, or benzyl; and the halide is Cl or Br, to make the symmetrical hafnium metallocene having isobutyl cyclopentadienyl ligands of structure (I) wherein each X is (C₁-C₅)alkyl, CH₂SiMe₃, or benzyl.

7. A metallocene catalyst composition comprising:
the symmetrical hafnium metallocene having isobutyl cyclopentadienyl ligands of claim 1, or
an activator.

8. The metallocene catalyst composition of claim 7 further comprising a support.

9. The metallocene catalyst composition of claim 8, wherein the composition is a spray-dried metallocene catalyst composition.

10. A method of making the metallocene catalyst composition of claim 7, the method comprising either: contacting the symmetrical hafnium metallocene having isobutyl cyclopentadienyl ligands with the activator but not the support, to give the metallocene catalyst composition without a support; or contacting the symmetrical hafnium metallocene having isobutyl cyclopentadienyl ligands with the activator and the support to give the metallocene catalyst composition with the support; or contacting the symmetrical hafnium metallocene having isobutyl cyclopentadienyl ligands with the activator and the support in an inert solvent; or contacting the symmetrical hafnium metallocene having isobutyl cyclopentadienyl ligands with the activator and the support in an inert solvent to give a suspension thereof and spray-drying the suspension to give the spray-dried metallocene catalyst composition; or contacting the symmetrical metallocene having isobutyl cyclopentadienyl ligands in an inert solvent that can be contacted with a supported or spray dried activator (or slurry thereof) to give the spray-dried metallocene catalyst composition.

11. A method of making a polyolefin polymer, the method comprising:
polymerizing at least one olefin monomer with either the metallocene catalyst composition of claim 7, to make the polyolefin polymer; wherein preferably the at least one olefin monomer comprises ethylene and, optionally, a comonomer selected from the group consisting of propene and a (C₄-C₂₀)alpha-olefin.

12. The method of claim 11, wherein the at least one olefin monomer comprises ethylene and the comonomer; and wherein the polyolefin polymer has a molecular weight comonomer distribution index (MWCDI) from 0.10 to 10.00, as measured by the MWCDI Test Method described herein; wherein preferably the comonomer is selected from the group consisting of 1-butene, 1-hexene, and 1-octene.

13. A polyolefin polymer made by the method of claim 11.
